(19) United States
(12) Patent Application Publication
(10) Pub. No.: US 2008/0205368 A1
(43) Pub. Date: Aug. 28, 2008

(54) Base Station and Mobile Unit and Method for Controlling Them

(75) Inventor: Susumu KASHIWASE, Yokohama-shi (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi (JP)

(21) Appl. No.: 12/037,783

(22) Filed: Feb. 26, 2008

Related U.S. Application Data
(60) Provisional application No. 60/892,205, filed on Feb. 28, 2007.

(30) Foreign Application Priority Data
Feb. 28, 2007 (JP) 2007-050404

(51) Int. Cl. H04B 7/216

(52) U.S. Cl. 370/342

(57) ABSTRACT

A base station and a mobile unit and method for controlling them can retransmit a request for transition without any useless transmission. The base station receives from the mobile unit a request for transition of the mobile unit to a semi connected state in which the mobile unit comes into a power saving state, while holding a mobile unit identifier assigned for identifying the mobile unit by the base station, and the base station determines the state of the base station in response to the request. The base station transmits to the mobile unit a response to the request together with a reason for disallowance attached to the response when the request for transition is not allowable as a result of the determination of the state of the base station. The mobile unit controls the transmission of the request for transition according to the reason for disallowance.

### CROSS-REFERENCE TO RELATED APPLICATION

The present application claims the benefit of priority to a Provisional Application entitled “Base Station and Mobile Station and Controlling the Same (filed on Feb. 28, 2007), which was assigned Provisional Application No. 60/892205, and which is entirely incorporated herein by reference.

### BACKGROUND OF THE INVENTION

1. Field of the Invention

This invention relates to a method for controlling a base station and a method for controlling a mobile unit, and more particularly to the base station and the mobile unit in mobile wireless communication associated with semi connected states adapted in the CDMA2000 Evolution (Ultra Mobile Broadband: UMB).

2. Related Art Statement

Semi connected operation has been known, which is a function provided on the higher layer of the CDMA2000 series highly developed by the use of technologies such as the orthogonal frequency division multiple access (OFDMA) and the like.

In the semi connected operation, for the purpose of saving electric power, medium access control identifiers (MAC-ID) are assigned to mobile units, and the semi connected state is realized such that reception of assigned portions through down link (forward link: FL) is continued, but transmission through up link (reverse link: RL) is not performed.

The semi connected state has been adopted in CDMA2000 Air Interface Evolution (Loosely Backwards Compatible: LBC) (refer to Non-patent Literature 1), which is effective when used upon reception of PTT (push to talk). For example, with the PTT in cellular system, two or more terminals are treated as a group and at the same time they are in stand-by (idle) state or receiving state.

In other words, two or more terminals are grouped so that terminals other than terminals being used for transmission are brought into the receiving state. Therefore the semi connected state is used for the purpose of group calling in dispatch business and the like. In this operation style, the terminals operate for reception only for most of the time. Namely, the restriction of the transmission through the up link to the minimum contributes to reduction in power consumption.

When some terminals in a PTT (push to talk) group are used for transmitting information, other terminals in the group are used for receiving information. In order to change from the stand-by (idle) state to conversation state, it must necessarily be through access state so that it takes a longer time. Therefore, there is a problem that the initial portion of the conversation is broken up.

The terminals periodically transmit reports of reception state to a base station at intervals of long time, while monitoring of the down link (forward link) is continued. In the base station, the reports from the terminals are periodically monitored using timers, and when the timers are expired without these periodical reports, the semi connected state is ended.

In the semi connected state, the mobile unit performs the following operations or is in the following state.

(1) Power saving state

(2) Transmission with up link (reverse control channel) is not performed.

(3) The medium access control identifier x(MAC-ID) is held.

(4) Information about reverse or forward shared control channel (F-SCCH) is periodically monitored.

Moreover, the semi connected state is canceled when access attempt is performed for transmission with or via a reverse control channel, that is, upon transition to communicating state.

A technique for reducing power consumption of mobile terminal units has been disclosed in Patent Document Patent Document 1.

Patent Document 1: Japanese Patent Application Opened No. 2003-517,741

Non-patent Literature 1: 3GPP2 TSG-CC21-20061030-009R2-Qualcomm_Semi Connected_Mode.pdf

In the semi connected state, however, each of the terminals comes into a state in which the terminals operate only for reception, while the terminal remains holding an assigned medium access control identifier (MAC-ID) of a value of 5 to 8 bits assigned to every sector on air interface. Therefore, it is envisioned that the medium access control identifiers become insufficient. In other words, when terminals holding respective assigned medium access control identifiers move out of service area, the identifiers cannot be used for a certain period of time. Particularly, in the case that terminals go all together out of service area such as when a train or automobile enters an underground or tunnel, medium access control identifiers for a particular sector would become insufficient.

In order to preclude this situation, the base station is provided with messages for refusing requests from terminals. In the case of other than the lack of medium access control identifiers, the requests from terminals are also refused as well in the case that the base station does not support the semi connected state, the network does not support the semi connected state and the transition to the semi connected state could not be performed because too many communication channels (traffic channels) are assigned to mobile units in the area. In this case, since the terminals do not receive any reason for refusal from the base station, the terminals transmit the request for transition to the semi connected state again so that useless requests would be repeated.

### SUMMARY OF THE INVENTION

It is an object of the present invention to provide a method for controlling a base station and a method for controlling a mobile unit, can transmit a request for transition to a semi connected state without any useless request for retransmission.

In order to achieve the object described above,
the method for controlling a base station according to the present invention includes the steps of:

receiving from a mobile unit a request for transition of the mobile unit to a semi connected state in which the mobile unit comes into a power saving state, while the mobile unit remains holding a mobile unit identifier assigned for identifying the mobile unit by the base station;

determining the state of the base station in response to the request; and

transmitting to the mobile unit a response to the request together with reason for disallowance attached to the response in the case that the request for transition of the mobile unit to the semi connected state is not allowable as a result of the determination of the state of the base station.

In the present invention, preferably the base station determines the state of the base station based on whether or not the base station supports a function for the transition of the mobile unit to the semi connected state.

According to one embodiment of the present invention, when the base station does not support the function for the transition of the mobile unit to the semi connected state, the base station preferably transmits the request to the request along with the fact that the base station does not supports the function.

According to another embodiment of the present invention, it is preferable for the base station to determine or judge the state of the base station on the basis of an occupancy state of the base station.

According to another embodiment of the present invention, when an occupancy amount representing an occupancy state of the base station exceeds a predetermined value, preferably the base station transmits the response the request along with fact that the occupancy amount of the base station exceeds the predetermined value.

According to yet another embodiment of the present invention, it is preferable that the occupancy amount of the base station is based on a used number of mobile unit identifiers assigned by the base station for identifying mobile units or a remaining number of the mobile unit identifiers.

According to yet another embodiment of the present invention, preferably the occupancy amount of the base station is based on the number of communication channels assigned to mobile units by the base station or the remaining number of the communication channels.

According to yet another embodiment of the present invention,

the method for controlling a mobile unit includes the steps of:

transmitting from the mobile unit to a base station a request for transition of the mobile unit to a semi connected state in which the mobile unit comes into a power saving state, while the mobile unit remains holding a mobile unit identifier assigned by the base station for identifying the mobile unit,

receiving from the base station a response to the request, and

retransmitting the request for transition on the basis of reason for disallowance attached to the response when the received response indicates that the request for transition to the semi connected state is unallowable.

According to yet another embodiment of the present invention, when the reason for disallowance attached to the response indicates that the base station does not support a function for the transition of the mobile unit to the semi connected state, preferably the request for transition is not transmitted again, but in the case that a handoff of the mobile unit has been performed to another base station or sector, the request for transition is newly transmitted.

According to yet another embodiment of the present invention, when the reason for disallowance attached to the response indicates that an occupancy amount of the base station exceeds a predetermined value, the request for transition is preferably retransmitted after a predetermined time has elapsed.

According to yet another embodiment of the present invention, it is preferable that the occupancy amount of the base station is based on a used number of mobile unit identifiers assigned by the base station for identifying mobile units or a remaining number of the mobile unit identifiers.

According to yet another embodiment of the present invention, preferably the occupancy amount of the base station is based on the number of communication channels assigned to mobile units by the base station or the remaining number of the communication channels.

According to another aspect of the present invention, the base station includes;

a receiver for receiving from a mobile unit a request for transition of the mobile unit to a semi connected state in which the mobile unit comes into a power saving state, while the mobile unit remains holding a mobile unit identifier assigned by the base station for identifying the mobile unit, and

a transmitter for transmitting to the mobile unit a response to the request together with a reason for disallowance attached to the response when the request for transition to the semi connected state is unallowable as a result of a state determination of the base station, the state determination being performed in response to the request.

According to one embodiment of the present invention, preferably the state of the base station is determined or judged based on whether or not the base station supports a function for the transition of the mobile unit to the semi connected state.

According to another embodiment of the present invention, when the base station does not support the function for the transition of the mobile unit to the semi connected state, the transmitter preferably transmits a message of the fact that the base station does not support the function, the message being attached to the response to the request.

According to yet another embodiment of the present invention, the state of the base station is preferably determined on the basis of an occupancy state of the base station.

According to yet another embodiment of the present invention, when an occupancy amount representing the occupancy state of the base station exceeds a predetermined value, the transmitter preferably transmits a message of the fact that the occupancy amount of the base station exceeds the predetermined value, the message being attached to the response to the request.

According to yet another embodiment of the present invention, the occupancy amount of the base station is preferably based on a used number of mobile unit identifiers assigned by the base station for identifying mobile units or a remaining number of the mobile unit identifiers.

According to another embodiment of the present invention, the occupancy amount of the base station is preferably based on the number of communication channels assigned to mobile units by the base station or remaining number of the communication channels.

According to another aspect of the present invention, the mobile unit includes:

a transmitter for transmitting to a base station a request for transition of the mobile unit to a semi connected state in which the mobile unit comes into a power saving state, while the mobile unit remains holding a mobile unit remains holding a mobile unit identifier assigned by the base station for identifying the mobile unit,

a receiver for receiving from the base station a response to the request, and

a controller for controlling the transmitter as regards retransmission of the request for transition on the basis of a reason for disallowance attached to the response when the received response indicates that the request for transition to the semi connected state is unallowable.

According to one embodiment of the present invention, when the reason for disallowance attached to the response indicates that the base station does not support a function for the transition of the mobile unit to the semi connected state, preferably the controller controls the transmitter so as not to retransmit the request for transition, and in the case that a handoff of the mobile unit has been performed to another base station or sector, preferably the controller controls the transmitter so as to transmit the request for transition newly.

According to another embodiment of the present invention, when the reason for disallowance attached to the response indicates that an occupancy amount of the base station exceeds a predetermined value, after a predetermined time has elapsed preferably the controller controls the transmitter so as to retransmit the request for transition.

According to another embodiment of the present invention, the occupancy amount of the base station is preferably based on a used number of mobile unit identifiers assigned by the base station for identifying mobile units or a remaining number of the mobile unit identifiers.

According to yet another embodiment of the present invention, the occupancy amount of the base station is preferably based on the number of communication channels assigned to mobile units by the base station or the remaining number of the communication channels.

According to yet another embodiment of the present invention, a reason for rejection of request for transition to the semi connected state can be recognized on the side of the mobile unit. The transmission of the request for transition to the semi connected state by the mobile unit is optimized, and the transmission of the request can be performed without any useless transmission so that resources for transmission through up link (reverse link) can be saved.

### BRIEF DESCRIPTION OF THE DRAWINGS

The invention will be more fully understood by referring to the following detailed descriptions and claims taken in connection with the appended drawings:

FIG. 1 is a diagram illustrating the configuration of a base station of one embodiment according to the invention;

FIG. 2 is a block diagram illustrating the configuration of a mobile unit of the one embodiment according to the invention;

FIG. 3 is a flow chart illustrating the progression of control process of a base station;

FIG. 4 is a flow chart illustrating the progression of control process of a mobile unit;

FIG. 5 is a sequence diagram illustrating the exchange of messages between the base station and the mobile unit; and

FIG. 6 is a flow chart illustrating the progression of process by the mobile unit after reception of response for rejection.

### DESCRIPTION OF THE PREFERRED EMBODIMENTS

The best mode for carrying out the invention will be explained with reference to the drawings hereinafter.

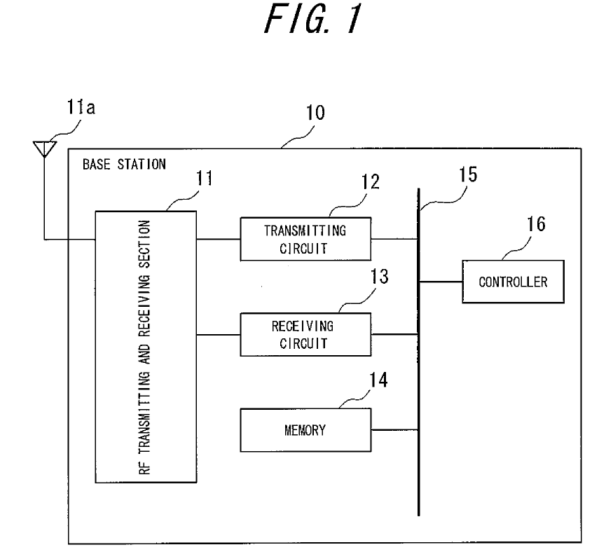

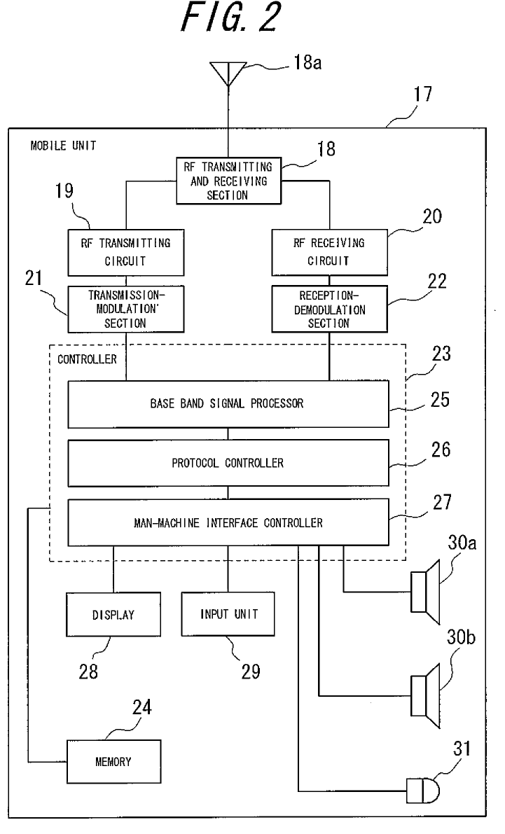

FIG. 1 is a block diagram illustrating the configuration of a base station according to one embodiment of the invention. As shown in FIG. 1, the base station 10 includes a radio frequency (RF) transmitting and receiving section 11 for exchanging signals through an antenna 11a between this section 11 and mobile units 17 (FIG. 2) later described such as, for example, communication terminal units as mobile phones, mobile station or the like, a transmitting circuit 12 and a receiving circuit 13 connected to the radio frequency transmitting and receiving section 11, a memory 14 for storing data to be processed in the base station 10, and a controller 16 connected through a bus 15 to the transmitting circuit 12, the receiving circuit 13 and the memory 14 for controlling operations of the components in the base station 10.

Moreover, although the term “base station” is used in the embodiment, it may be a sector.

The controller 16 cooperates with the respective components described above as needed to function as receiver which receives from the mobile unit 17 a request for transition to a semi connected state (Semi Connected Start) in which the mobile unit 17 comes into a power saving state, while the mobile unit 17 remains holding a mobile unit identifier (MAC-ID) assigned by the base station for identifying the mobile unit 17. In response to the request for the transition, the controller 16 determines the state of the base station 10. The controller 16 also functions as transmitter which transmits to the mobile unit 17 a response to the request for transition to the semi connected state together with a reason for rejection (Semi Connected Start Reject) in the case that the request for the transition to the semi connected state is not allowable, as a result of determination of the state of the base station 10.

The base station 10 determines or judges its state as regards whether the base station 10 supports the function for the transition of the mobile unit 17 to the semi connected state, and further determines the state of the base station or sector based on its occupancy amounts of the base section 10 or sector. If the base station 10 or sector does not support the function for the transition of the mobile unit 17 to the semi connected state, the transmitter transmits to the mobile unit 17 a message of the fact that the function is not supported, the message being attached to the response to the request for the transition. In the case that occupancy amounts in the base station 10 or sector exceed the predetermined values in the base station 10 or sector, the transmitter transmits to the mobile unit 17 a message of the fact that the occupancy amounts of the base station 10 or sector exceed the predetermined values, the message being attached to the response to the request for the transition.

The occupancy amounts of the base station 10 or sector are based on the used number of the mobile unit identifiers assigned for identifying mobile units 17 by the base station 10 or sector or the remaining number of the mobile unit identifiers, and further based on the number of communication channels assigned to the mobile units 17 by the base station 10 or sector or the remaining number of the communication channels.

FIG. 2 is a block diagram illustrating the configuration of the mobile unit 17 according to one embodiment of the invention. As shown in FIG. 2, the mobile unit 17 includes a radio frequency (RF) transmitting and receiving section 18 for exchanging signals through an antenna 18a between the mobile unit 17 and the base station 10 (FIG. 1), a radio frequency transmitting circuit 19 and a radio frequency receiving circuit 20 connected to the radio frequency transmitting and receiving section 18, a transmission-modulation section 21 connected to the radio frequency transmitting circuit 19, a reception-demodulation section 22 connected to the radio frequency receiving circuit 20, a controller 23 connected to the transmission-modulation section 21 and the reception-demodulation section 22, and a memory 24 connected to the controller 23.

The controller 23 includes a base band signal processor 25 connected to the transmission-modulation section 21 and the reception-demodulation section 22, a protocol controller 26 connected to the base band signal processor 25, and a man-machine interface controller 27 connected to the protocol controller 26.

Connected to the man-machine interface controller 27 are a display 28 such as a liquid crystal display (LCD) or the like, an input unit 29 such as a keyboard or the like for inputting information, speakers 30a and 30b, and a microphone 31.

The controller 23 cooperates with the respective components described above as needed to function as transmitter which transmits to the base station 10 the request for the transition to the semi connected state in which the mobile unit 17 comes into the power saving state, while the mobile unit 17 remains holding the mobile unit identifier assigned by the base station 10 for identifying the mobile unit 17. The controller 23 also functions as receiver which receives from the base station 10 the response to the request for the transition. In the case that the received response indicates that the request for transition to the semi connected state is not allowable, the controller 23 functions as controller for controlling a retransmission of the request for the transition based on the reason for disallowance attached to the response.

Moreover, in the semi connected state, the mobile unit 17 performs the following operations or is in the following state.

(1) Power saving state

(2) Transmission with reverse control channels is not performed.

(3) The medium access control identifier (MAC-ID) is held.

(4) Information about reverse or forward shared control channel (F-SCCH) is periodically monitored.

Moreover, the semi connected state is canceled when access attempt is performed for transmission with a reverse control channel, that is, upon transition to communicating state.

When the reason for disallowance attached to the response indicates that the base station 10 or sector does not support the function for the transition of the mobile unit 17 to the semi connected state, the controller 23 of the mobile unit 17 controls the transmitting section so as not to retransmit the request for the transition. In the case handing off to another base station or sector, the controller 23 controls the transmitting section to transmit newly to that another base station or sector the request for the transition. In the case that the reason for disallowance attached to the response indicates that occupancy amounts in the base station 10 or sector exceed the predetermined values of the base station 10 or sector, the controller 23 controls the transmitting section to retransmit to the base station 10 the request for the transition after a predetermined time has elapsed.

Moreover, the occupancy amounts of the base station 10 or sector are based on the used number of the mobile unit identifiers assigned for identifying the mobile units 17 by the base station 10 or sector or remaining number of the mobile unit identifiers, and further based on the number of communication channels assigned to the mobile units 17 by the base station 10 or sector or remaining number of the communication channels.

As a precaution against the lack of medium access control identifiers (MAC-ID) in a particular sector, the transition to the semi connected state in the particular sector is prohibited.

In order to prohibit the transition to the semi connected state in a particular base station or sector, it is possible to use a semi connected start reject message.

The network can prohibit the transition of the terminal unit (mobile unit 17) to the semi connected state by making a response to a request for transition (Semi Connected Start) from the terminal unit (mobile unit 17).

According to the “reject reason” attached as message parameters to the response message, the terminal unit changes the timing at which a request for transition is transmitted again, thereby reducing unnecessary traffics.

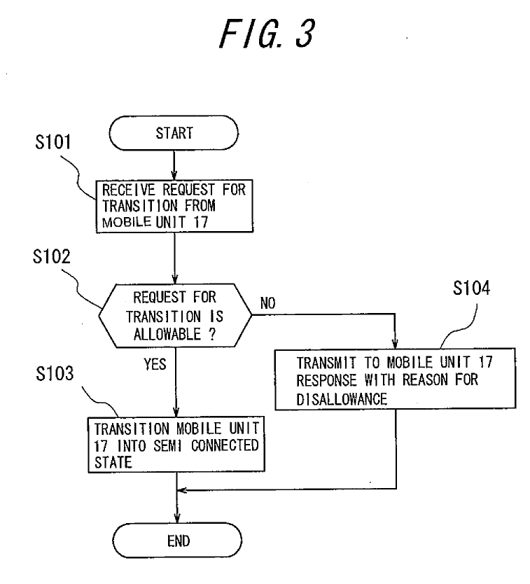

In other words, in the case that the “reject reason” indicates that the base station or sector does not support the function for the transition of the mobile unit 17 to the semi connected state, a request for transition is not transmitted until the mobile unit 17 is handed off to another base station or sector. Moreover, in the case that the “rejection reason” indicates that required identifiers or communication channels exceed or are about to exceed buffer amounts (admissible amounts, or accommodated amounts), such as the lack of medium access control identifiers (MAC-ID), communication cannels channels and the like, which can be controlled by the current base station or sector, the request for transition can be transmitted again to the base station or sector after a predetermined time has elapsed, even if the mobile unit is in the same base station or sector. Methods for controlling the base station 10 and the mobile unit 17 will then be explained. FIG. 3 is a flow chart illustrating the progression of control process of the base station 10. As shown in FIG. 3, first, the base station 10 receives from the mobile unit 17 a request for transition to a semi connected state in which the mobile unit 17 comes into the power saving state (step S 101). At this time, the mobile unit 17 remains holding the mobile unit identifier (MAC-ID) assigned for identifying the mobile unit 17 by the base station 10.

In response to the request for transition, the state of the base station 10 or sector is then determined or judged whether or not the request for transition is allowable (step S102). In this case, the state of the base station 10 or sector is determined based on whether or not the base station 10 or sector supports the function for the transition of the mobile unit 17 to the semi connected state. Moreover, the state of the base station 10 or sector is determined based on the occupancy state at present.

As a result of the determination of the state, if the request for transition to the semi connected state is allowable (YES), the mobile unit 17 is transitioned into the semi connected state (step S103) and thereafter this process is ended. On the other hand, if the request for transition to the semi connected state is not allowable (NO), a response to the request for transition is transmitted together with the reason for disallowance to the mobile unit 17 (step S104) and thereafter this process is ended.

In other words, if the base station 10 or sector does not support the function for the transition of the mobile unit 17 to the semi connected state, the base station 10 or sector transmits the response to the request for the transition together with a message of the fact that the base station 10 or sector does not support the function. Moreover, the state of the base station 10 or sector is determined on the basis of the occupancy amounts of the base station 10 or sector at present. If the occupancy amounts of the base station 10 or sector exceed predetermined values, the response to the request for transition is transmitted to the mobile unit 17 together with a message of the fact that the occupancy amounts of the base station 10 or sector exceed the predetermined values.

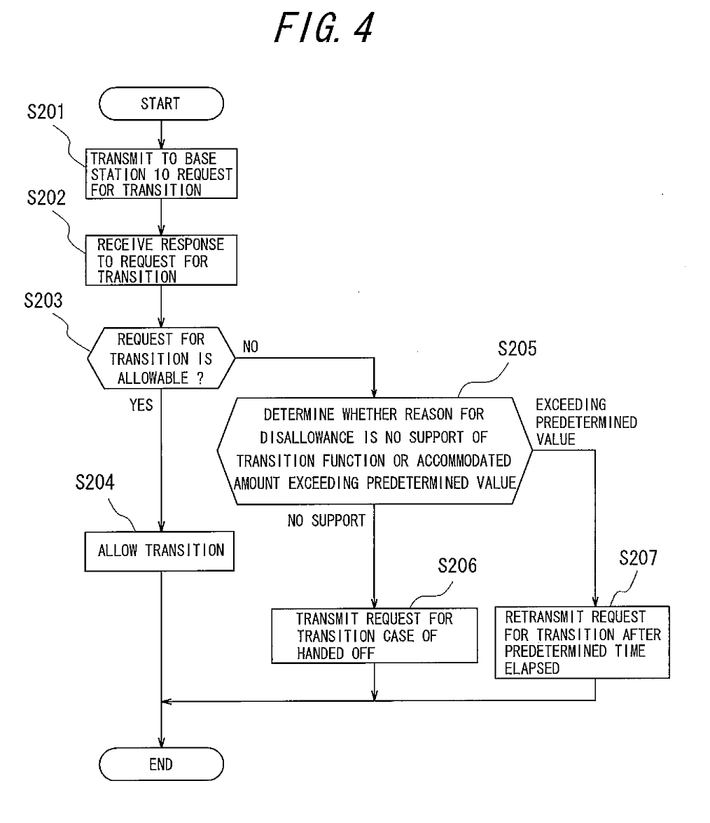

FIG. 4 is a flow chart illustrating the progression of control process of the mobile unit. As shown in FIG. 4, first, transmitted to the base station 10 is the request for transition of the mobile unit 17 to the semi connected state which brings the mobile unit 17 into a power saving state (step S201). The mobile unit 17 remains holding the mobile unit identifier (MAC-ID) assigned by the base station 10 for identifying the mobile unit 17.

Then, the mobile unit 17 receives from the base station 10 a response to the request for transition (step S202), and determines whether or not the received response indicates that the request for transition to the semi connected state is allowable (step S203). If it is allowable (YES), the transition to the semi connected state is permitted (step S204), and after the transition, this process is ended.

On the other hand, if disallowance is indicated (NO), the request for transition is retransmitted on the basis of the reason for disallowance. Before the retransmission, however, the reason for disallowance attached to the response is examined (step S205). If the reason for disallowance attached to the response indicates that the base station 10 or sector does not support the function for the transition of the mobile unit 17 to the semi connected state, the request for transition is not retransmitted. In this case, the mobile unit 17 waits for handing off to another station or sector. After the handing off of the mobile unit 17 to that another station has been completed, request for transition is newly transmitted to that another station or sector (step S206). Moreover, if the reason for disallowance attached to the response indicates that the occupancy amounts of the base station 10 or sector exceed the predetermined values, after a predetermined time has elapsed, the request for transition is retransmitted to the base station (step S207).

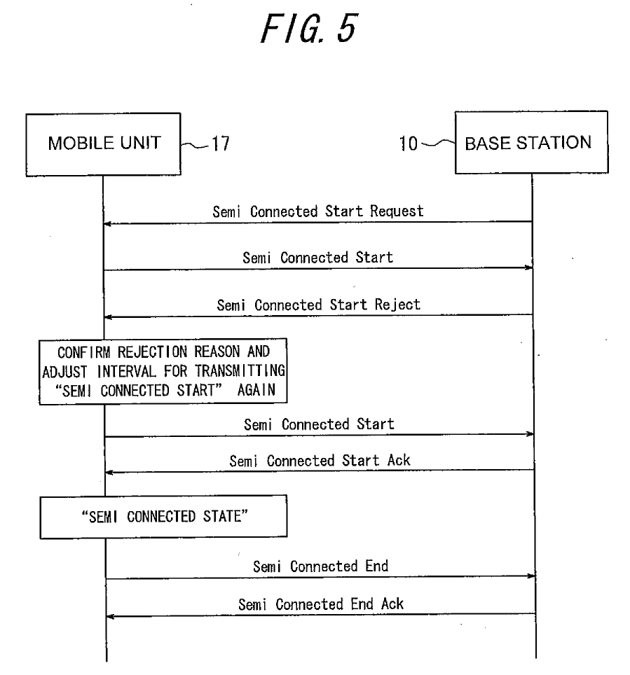

FIG. 5 is a sequence diagram illustrating the exchange of messages between the base station and the terminal unit. In FIG. 5, moreover, it is assumed that occupancy amounts of the base station 10 at present exceed or are about to exceed predetermined values. As shown in FIG. 5, a request for starting the semi connected state is transmitted from the base station 10 to the terminal unit (mobile unit 17).

The mobile unit 17, which has received the request for starting the semi connected state, transmits a request for transition to the semi connected state (Semi Connected Start) to the base station 10. Upon receipt of the request, the base station 10 transmits to the mobile unit 17 a response for rejection (Semi Connected Start Reject) together with reason for rejection attached thereto. Upon receipt of the response for rejection from the base station 10, the mobile unit 17 confirms the reason for rejection and holds back transmission until a predetermined interval has elapsed by adjusting the request-transmission interval (by means of a timer or the like). Again, the request for transition to the semi connected state is transmitted to the base station 10. At this moment, if the occupancy state of the base station 10 has been changed (occupancy amounts are less than the predetermined values) and it becomes possible to bring the mobile unit 17 into the semi connected state, a confirmation acknowledge (Semi Connected Start Acknowledge) is transmitted from the base station 10 to the mobile unit 17. Upon receipt of the confirmation acknowledge, the mobile unit 17 is transitioned into the semi connected state.

In the case that the semi connected state is then ended, the mobile unit 17 transmits the end of the semi connected state (Semi Connected End) to the base station 10. Upon receipt of the semi connected end, the base station 10 transmits a confirmation acknowledge to the mobile unit 17.

In the sequence shown in FIG. 5, the transmission of the request for starting the semi connected state (Semi Connected Start Request) from the base station 10 may be omitted, and the sequence may be started from the transmission of the request for transition to the semi connected state from the mobile unit 17 (in the case giving preference to the mobile unit over the base station).

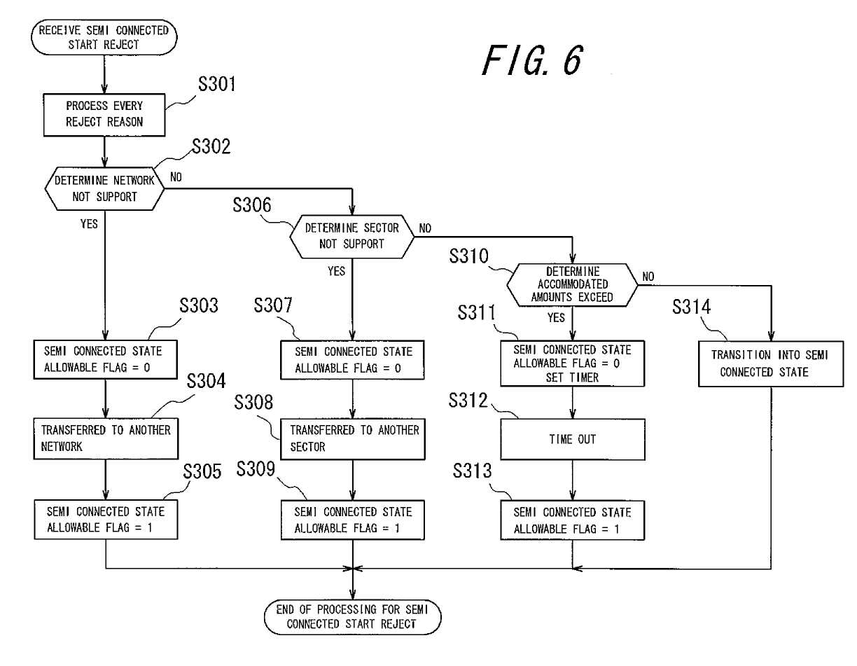

FIG. 6 is a flow chart illustrating the progression of process by the mobile unit after the receipt of the response for rejection. As shown in FIG. 6, upon receipt of the response for rejection transmitted from the base station 10 to the mobile unit 17, the mobile unit 17 performs the processes for respective reasons for rejection (Reject Reason) (step S301), and thereafter the mobile unit 17 checks the fact that the network does not support the function for the transition of the mobile unit to the semi connected state (Network NOT Support) (step S302). In the case that the network does not support the function for the transition of the mobile unit to the semi connected state (YES), a semi connected state allowable flag is set to zero (=0) (step S303). Therefore, the transmission of request for transition to the semi connected state is prohibited.

Then, when a transfer of the mobile unit to another network has been detected (step S304), the semi connected state allowable flag is set to one (=1) (step S305) so that it becomes possible to transmit the request for transition to the semi connected state, and thereafter this process for the response of rejection is ended.

In step S302, if the network supports the function (NO), the fact that the sector or base station does not support the function (Sector Not Support) is checked (step S306). If the sector does not support the function for the transition of the mobile unit to the semi connected state (YES), the semi connected state allowable flag is set to zero (=0) (step S307).

Then, if the fact that the transfer to a different sector has been detected (step S308), the semi connected state allowable flag is set to one (=1) (step S309), and thereafter this process for the response of rejection is ended.

In the step S306, if the sector or base station supports the function for the transition of the mobile unit (NO), whether the occupancy amounts at present exceed the predetermined amounts is checked (step S310). If the occupancy amounts in the sector or base station exceed or are about to exceed the predetermined values (YES), the semi connected state allowable flag is set to zero (=0), and a predetermined time is set and a timer is activated (step S311).

If time out is then detected (step S312), the semi connected state allowable flag is set to one (=1) (step S313) and thereafter the process for the response of rejection is ended.

In the step S310, in the case that the transition to the semi connected state is allowed (NO), the mobile unit is transitioned into the semi connected state (step S314).

Although the present invention has been explained with the several embodiments described above, it is to be understood that the invention is not limited by such embodiments. Therefore, the invention also includes any changes and variations carried out as embodiments without departing from the scope and spirit of the present invention.

What is claimed is:

1. A method for controlling a base station comprising the steps of:
receiving from a mobile unit a request for transition of the mobile unit to a semi connected state in which the mobile unit comes into a power saving state, while the mobile unit remains holding a mobile unit identifier assigned for identifying the mobile unit by the base station;
determining the state of the base station in response to the request; and
transmitting to the mobile unit a response to the request together with reason for disallowance attached to the response when the request for transition of the mobile unit to the semi connected state is not allowable as a result of the determination of the state of the base station.

2. The method for controlling a base station as claimed in claim 1,
wherein the base station determines the state of the base station based on whether or not the base station supports a function for the transition of the mobile unit to the semi connected state.

3. The method for controlling a base station as claimed in claim 2,
wherein when the base station does not support the function for the transition of the mobile unit to the semi connected state, the base station transmits a message of the fact that the base station does not supports the function, the message being attached to the response to the request.

4. The method for controlling a base station as claimed in claim 1,
wherein the base station determines the state of the base station on the basis of an occupancy state of the base station.

5. The method for controlling a base station as claimed in claim 4,
wherein when an occupancy amount representing an occupancy state of the base station exceeds a predetermined value, the base station transmits a message of the fact that the occupancy amount of the base station exceeds the predetermined value, the message being attached to the response to the request.

6. The method for controlling a base station as claimed in claim 4,
wherein the occupancy amount of the base station is based on a used number of mobile unit identifiers assigned by the base station for identifying mobile units or a remaining number of the mobile unit identifiers.

7. The method for controlling a base station as claimed in claim 4,
wherein the occupancy amount of the base station is based on the number of communication channels assigned to mobile units by the base station or the remaining number of the communication channels.

8. A method for controlling a mobile unit comprising the steps of:
transmitting from the mobile unit to a base station a request for transition of the mobile unit to a semi connected state in which the mobile unit comes into a power saving state, while the mobile unit remains holding a mobile unit identifier assigned by the base station for identifying the mobile unit;
receiving from the base station a response to the request; and
retransmitting the request for transition on the basis of reason for disallowance attached to the response when the received response indicates that the request for transition to the semi connected state is unallowable.

9. The method for controlling a mobile unit as claimed in claim 8,
wherein when the reason for disallowance attached to the response indicates that the base station does not support a function for the transition of the mobile unit to the semi connected state, the request for transition is not transmitted again, but when a handoff of the mobile unit has been performed to another base station or sector, the request for transition is newly transmitted.

10. The method for controlling a mobile unit as claimed in claim 8,
wherein when the reason for disallowance attached to the response indicates that an occupancy amount of the base station exceeds a predetermined value, the request for transition is retransmitted after a predetermined time has elapsed.

11. The method for controlling a mobile unit as claimed in claim 10,
wherein the occupancy amount of the base station is based on a used number of mobile unit identifiers assigned by the base station for identifying mobile units or a remaining number of the mobile unit identifiers.

12. The method for controlling a mobile unit as claimed in claim 10,
wherein the occupancy amount of the base station is based on the number of communication channels assigned to mobile units by the base station or the remaining number of the communication channels.

13. A base station comprising:
a receiver for receiving from a mobile unit a request for transition of the mobile unit to a semi connected state in which the mobile unit comes into a power saving state, while the mobile unit remains holding a mobile unit identifier assigned by the base station for identifying the mobile unit, and
a transmitter for transmitting to the mobile unit a response to the request together with a reason for disallowance attached to the response when the request for transition to the semi connected state is unallowable as a result of a state determination of the base station, the state determination being performed in response to the request.

14. The base station as claimed in claim 13, wherein the state of the base station is determined based on whether or not the base station supports a function for the transition of the mobile unit to the semi connected state.

15. The base station as claimed in claim 14, wherein when the base station does not support the function for the transition of the mobile unit to the semi connected state, the transmitter transmits a message of the fact that the base station does not support the function, the message being attached to the response to the request.

16. The base station as claimed in claim 13, wherein the state of the base station is determined on the basis of an occupancy state of the base station.

17. The base station as claimed in claim 16, wherein when an occupancy amount representing the occupancy state of the base station exceeds a predetermined value, the transmitter transmits a message of the fact that the occupancy amount of the base station exceeds the predetermined value, the message being attached to the response to the request.

18. The base station as claimed in claim 16, wherein the occupancy amount of the base station is based on a used number of mobile unit identifiers assigned by the base station for identifying mobile units or a remaining number of the mobile unit identifiers.

19. The base station as claimed in claim 16, wherein the occupancy amount of the base station is based on the number of communication channels assigned to mobile units by the base station or the remaining number of the communication channels.

20. A mobile unit comprising:
transmitter for transmitting to a base station a request for transition of the mobile unit to a semi connected state in which the mobile unit comes into a power saving state, while the mobile unit remains holding a mobile unit identifier assigned by the base station for identifying the mobile unit,
receiver for receiving from the base station a response to the request, and
controller for controlling the transmitter as regards retransmission of the request for transition on the basis of a reason for disallowance attached to the response when the received response indicates that the request for transition to the semi connected state is unallowable.

21. The mobile unit as claimed in claim 20, wherein in the case that the reason for disallowance attached to the response indicates that the base station does not support a function for the transition of the mobile unit to the semi connected state, the controller controls the transmitter so as not to retransmit the request for transition, and when a handoff of the mobile unit has been performed to another base station or sector, the controller controls the transmitter so as to transmit the request for transition newly.

22. The mobile unit as claimed in claim 20, wherein in the case that the reason for disallowance attached to the response indicates that an occupancy amount of the base station exceeds a predetermined value, after a predetermined time has elapsed the controller controls the transmitter so as to retransmit the request for transition.

23. The mobile unit as claimed in claim 22, wherein the occupancy amount of the base station is based on a used number of mobile unit identifiers assigned by the base station for identifying mobile units or a remaining number of the mobile unit identifiers.

24. The mobile unit as claimed in claim 22, wherein the occupancy amount of the base station is based on the number of communication channels assigned to mobile units by the base station or the remaining number of the communication channels.
